(19) United States
(12) Patent Application Publication
(10) Pub. No.: US 2008/0231119 A1
(43) Pub. Date: Sep. 25, 2008

(54) Uninterruptible power storage device

(76) Inventor: Ming-Hsiang Yeh, Taipei City (TW)

Correspondence Address: TROXELL LAW OFFICE PLLC, SUITE 1404, 5205 LEESBURG PIKE, FALLS CHURCH, VA, 22041, US

(21) Appl. No.: 11/723,397

(22) Filed: Mar. 19, 2007

(51) Int. Cl. H02J 9/06

(52) U.S. Cl. 307/65; 307/66

(57) ABSTRACT

An uninterruptible power storage device includes multiple power sources and an uninterruptible power equipment, wherein the uninterruptible power equipment has functions of rectification, transformation and charging and comprises a battery for storing electricity, multiple input terminals for connecting to multiple power sources, a built-in power source distributor, which has a power factor correction/PV inverter, two MPPT chargers and a bridge rectifier, and an output terminal for connecting to an electric appliance. Through a power distribution by the power source distributor, a best beneficial result of power supply combining the power sources at the input terminals can be achieved.

### FIELD OF THE INVENTION

The present invention is related to an uninterruptible power storage device with the capability of distributing multiple power sources, and more particularly to an uninterruptible power storage device suitable for all kinds of electric appliances and the likes.

### BACKGROUND OF THE INVENTION

Non-warned power interruption always causes damages to industries, especially for some particular manufacturers or equipments, inestimable losses might be resulted. Take the computer as an example. It is known that, without backup, the non-warned power interruption will cause the data in processing missing which might lead to a serious consequence. Therefore, for preventing this kind of accident, various uninterruptible power systems (UPS) are disclosed for immediately re-supplying the interrupted power source, thereby a plenty of time can be provided to finish data storage and shutdown the computer so as to reduce the damage caused from power interruption.

However, although the above-described UPS system can provide the electric appliance the power for continuous operation, the supplying time thereof is actually very short since the UPS system is only designed to release the power, which is stored as the mains electricity is supplied, so that the UPS system obviously can't supply sufficient power for continuously long-term operation and the normal operation of computer still have to wait for the recovery of mains electricity. Hence, this kind of UPS system whose power storage is only supplied by mains electricity is actually an uneconomical method for power backup, especially that, nowadays, the problem of inadequate energy source become more and more serious.

For improving, UPS systems which employ other power sources are disclosed. For example, one kind of UPS system employs battery for storing electricity. This kind of UPS system has only one power input from the mains electricity and the backup power source thereof is the battery, but identically, the power supplied by the battery is still insufficient for long-term backup demand. Consequently, because of the technical defects of described above, the applicant keeps on carving unflaggingly through wholehearted experience and research to develop an uninterruptible power storage device, which has the capability of distributing multiple power sources.

### SUMMARY OF THE INVENTION

The object of the present invention is to provide an uninterruptible power storage device which has the capability of distributing multiple power sources.

For achieving the object described above, the present invention includes multiple power sources and an uninterruptible power equipment, wherein the uninterruptible power equipment has functions of rectification, transformation and charging and comprises a battery for storing electricity, multiple input terminals for connecting to multiple power sources, a built-in power source distributor, which has a power factor correction/PV inverter, two MPPT chargers and a bridge rectifier, and an output terminal for connecting to an electric appliance. Through a power distribution by the power source distributor, a best beneficial result of power supply combining the power sources at the input terminals can be achieved.

### BRIEF DESCRIPTION OF THE DRAWINGS

The foregoing aspects and many of the attendant advantages of this invention will be more readily appreciated as the same becomes better understood by reference to the following detailed description, when taken in conjunction with the accompanying drawings, wherein:

FIG. 1 is a block diagram showing the framework of the present invention;

FIG. 2 is a detailed circuit diagram showing a power source distributor according to the present invention; and

FIG. 3 is a block diagram showing the operation of the present invention.

### DESCRIPTION OF THE PREFERRED EMBODIMENT

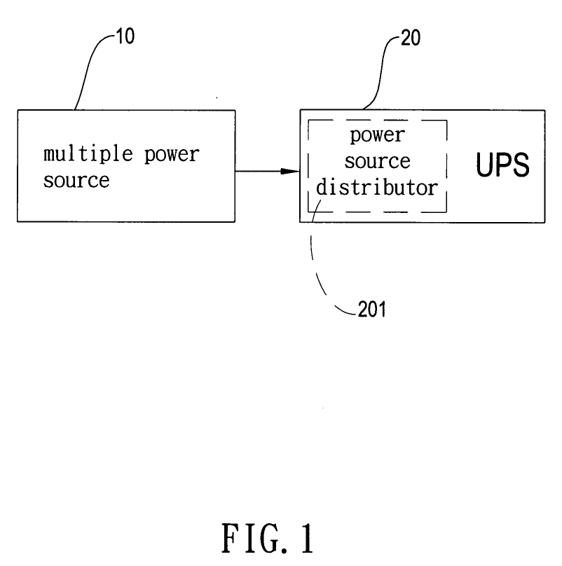

Please refer to FIG. 1, the present invention includes: multiple power sources 10 and an interruptible power equipment 20, wherein the power sources can be a DC power source or AC power source, for example, the mains electricity or any kind of power generator, such as wind power generator, water power generator, or solar power generator, and the interruptible power equipment 20 includes multiple power input terminals connected to the multiple power sources 10, a built-in power source distributor 201 and an output terminal connected to an electric appliance 30.

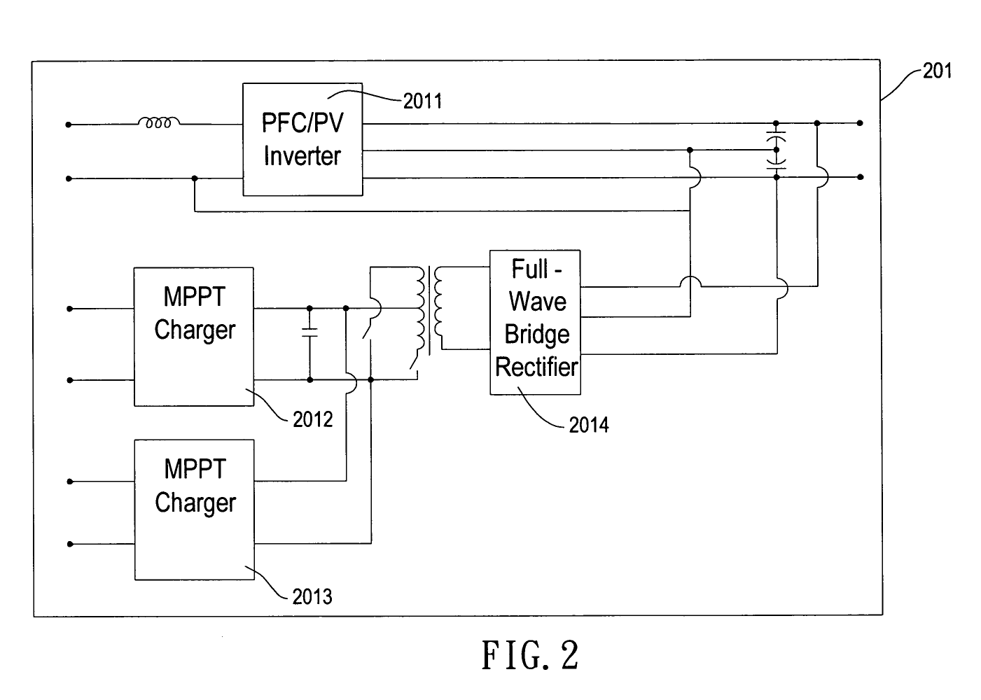

Please refer to FIG. 2, the power source distributor 201 includes plural capacitors, an inductor, a power factor correction/PV inverter 2011, two MPPT chargers 2012, 2013, and a bridge rectifier 2014.

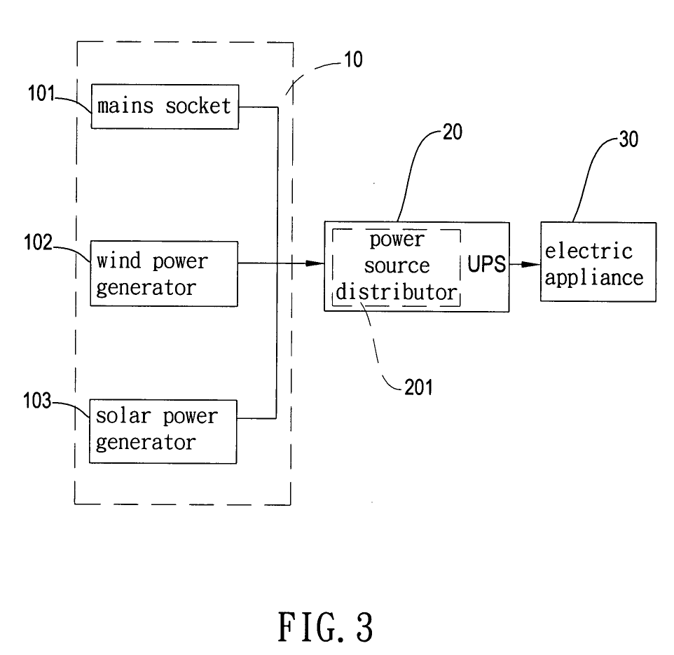

Please refer to FIG. 3, in this embodiment, for example, the multiple power sources 10 are mains socket 101, wind power generator 102, and solar power generator 103. When the power from the solar power generator is insufficient (for example, the sun is covered by the cloud), the two MPPT chargers 2012, 2013 in the power source distributor 201 will start to realize the amount of electricity from each power source. If the power source distributor 201 discovers that the wind power generator 102 can generate the greatest amount of electricity, then it will decide to supplement the insufficient power by the wind power generator 102. Or, owing to the user's plan (for example, the preferential price in the off-peak period, or the subsidization from the government), the solar energy is regarded as the first priority in certain period/season and the wind power generator becomes the second priority for supplementing, and if the power is still sufficient, then the mains electricity serves as the next supplement. Or, a plan directly limiting the priority or proportion of each power source under certain period of time or date, or situation can be provided, so that a best benefit for the user can be achieved.

Alternatively, when the mains socket 101 stops power supply, the interruptible power equipment 20 will release the stored electricity, and after a period of time, if the mains electricity still remains broken and the electricity storage in UPS system 20 becomes less and less, the two MPPT chargers 2012, 2013 in the power source distributor 201 will start to realize and confirm which of the wind power generator 102 and the solar power generator 103 has a greater amount of electricity, so that the generator with a greater amount of electricity will be selected to supply the power.

Furthermore, according to the demands from the user, the power source distributor 201 also can plan the power source distribution through the functions of software and hardware thereof, so that no matter the supply from the main power source stops or not, this design will directly search the second greater power or other power generator to be the power source and distribute the proportion and operation time of each power source according to the user's plan.

As described above, the advantages possessed by the present invention are as followed:

1. Through multiple built-in power source terminals and the power distribution capability of the power source distributor, the uninterruptible power equipment can distribute the proportion, priority and operation time of each power source according to the user's plan (such as, under certain condition, or some periods or dates), so as to achieve a best benefit among all power sources.

2. The uninterruptible power equipment can release the stored power to be the backup power source if it's during a peak hour, the power source has a lower quality or is not stable, or the mains electricity stops, and after the stored electricity is consumed and reduced to a predetermined level and the supply of mains electricity is still not restored, the power source distributor will automatically realize the situation of each power source so as to decide a best policy for power combination.

3. The risk caused from unstable electricity during power conversion and distribution can be avoided since the present invention employs the UPS function as the backup power source for smoothing the whole process.

4. The design of the present invention can become the power source control center in each family/company under the diversification policy in power sources.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. An uninterruptible power storage device comprising multiple power sources and an uninterruptible power equipment, wherein the uninterruptible power equipment has functions of rectification, transformation and charging and comprises a battery for storing electricity, multiple input terminals for connecting to multiple power sources, a built-in power source distributor, which has a power factor correction/PV inverter, two MPPT chargers and a bridge rectifier, and an output terminal for connecting to an electric appliance, and through a power distribution by the power source distributor, a best beneficial result of power supply combining the power sources at the input terminals is achieved.

2. The uninterruptible power storage device as claimed in claim 1, wherein the multiple power sources comprises DC or AC power sources.

3. The uninterruptible power storage device as claimed in claim 1, wherein the multiple power sources are mains electricity, wind power generator, gasoline/diesel power generator, fuel cell power generator, solar power generator and other power source suppliers.
